(19) United States
(12) Patent Application Publication
(10) Pub. No.: US 2025/0237379 A1
(43) Pub. Date: Jul. 24, 2025

(54) METHODS FOR PROVIDING ENHANCED STAGED OXYGEN CONTROL OXYGEN COMBUSTION AND DEVICES THEREOF

(71) Applicant: Selas Heat Technology Company LLC, Streetsboro, OH (US)

(72) Inventors: Scott C. Anderson, Orlando, FL (US); David Fontes, Englewood, FL (US)

(73) Assignee: Selas Heat Technology Company LLC, Streetsboro, OH (US)

(21) Appl. No.: 18/853,666

(22) PCT Filed: Apr. 4, 2022
(86) PCT No.: PCT/US2022/071523

§ 371 Date: Oct. 2, 2024

(51) Int. Cl. F23C 6/04; C03B 5/24; F23D 14/32; F23D 23/00; F23N 1/00; F27D 19/00

(52) U.S. Cl. CPC F23C 6/047; C03B 5/24; F23D 14/32; F23D 23/00; F23N 1/002; F27D 19/00; F23N 2235/12; F23N 2237/02; F27D 2019/0006

(57) ABSTRACT

A method for providing automatic enhanced staged oxygen combustion in a glass furnace including providing two or more burner assemblies each positioned to provide a flame in the glass furnace. Each of the burner assemblies includes a burner body having a primary gas inlet in fluid communication with a gas source through a primary gas valve, and a staged injector sub-assembly having a secondary gas inlet in fluid communication with the gas source through a secondary gas valve. The primary gas valve and the secondary gas valve are automatically controlled to alternate the total gas flow between a first total gas flow condition with the secondary gas flow rate at a secondary gas flow rate maximum value and a second total gas flow condition with the secondary gas flow rate at a secondary gas flow rate minimum value to provide enhanced staged oxygen combustion.

### FIELD

The present disclosure is directed generally to methods of oxygen combustion, and more specifically, to methods for providing automatic enhanced staged oxygen control oxygen combustion and devices thereof.

### BACKGROUND

Oxy-fuel combustion is the process of burning a fuel using oxygen as the primary oxidant instead of air. Use of oxy-fuel combustion lowers harmful environmental emissions as the nitrogen component of the air oxidant is eliminated, reducing nitrogen oxide (NOx) emissions, as well as decreasing fuel consumption. Oxy-fuel combustion is utilized, for example, in glass furnaces for glass melting processes.

The first burners used in oxy-fuel combustion in glass melting processes were conical flame or “tube in tube” burners. The development of flat flame burners improved flame coverage, lowered fuel use and provided for decreased NOx emissions due to low fuel and oxygen velocities. Crown firing burners were developed and used in low or no boron fiberglass. However, that technology was not transferable to other glasses due to volatilization issues as the flame hits the glass surface.

Subsequently, flat flame burners were enhanced by (1) staging the oxygen flow to a separate port in the burner and burner block and (2) using preheating fuel within the burner creating a high luminosity flame. Both techniques resulted in further reduction in NOx emissions and reductions in fuel use.

Due to high cullet ratios and issues with cullet quality, further improvements to burners to enhance melting and foam reduction in the furnace were needed for container glass. Additionally, oxy-fuel combustion creates a higher concentration of moisture that results in higher foam formation. To minimize these effects, staged oxygen was diverted to the top of the burner. Additionally, other burners with separate ports for fuel and oxygen were set to increase the fuel and reduced firing conditions close to the glass.

### SUMMARY

The present disclosure is directed generally to methods of oxygen combustion, and more specifically, to methods for providing enhanced staged oxygen control oxygen combustion and devices thereof. Applicant has recognized and appreciated that it is beneficial to completely separate the staged oxygen from the primary burner. The burner designs and methods contemplated herein that include or omit staging provide improvements in the flows of gases through a burner thereby producing a thicker and more evenly distributed flame as compared with traditional flat flame burners. Conventional methods for controlling staged oxygen involve manually settings the staged oxygen at the burner based upon a valve setting at the burner and the setting is fixed. The methods and systems of the present disclosure allow for automated control of the amount of staged gas, such as oxygen, provided during glass melting processes. Automated control of the amount of staged gas allows for pulsing of the staged gas to produce variation in carbon monoxide (CO) and pressure over the glass surface and glass foam to minimize the secondary foam produced to improve the overall oxy-fuel combustion glass melting process.

One aspect of the present disclosure relates to a method for providing automatic enhanced staged oxygen combustion in a glass furnace. The method includes providing two or more burner assemblies each positioned to provide a flame in the glass furnace. Each of the two or more burner assemblies includes a burner body comprising a primary gas inlet for receiving a primary gas flow from a gas source, the primary gas inlet in fluid communication with the gas source through a primary gas flow control valve configured to adjust a primary gas flow rate of the primary gas flow, and a staged injector sub-assembly comprising a secondary gas inlet for receiving a secondary gas flow from the gas source, the secondary gas inlet in fluid communication with the gas source through a secondary gas flow control valve configured to adjust a secondary flow rate of the secondary gas flow. A total gas flow for each of the two or more burner assemblies is provided by the primary gas flow and the secondary gas flow. The primary gas flow control valve and the secondary gas flow control valve of at least two of the two or more burner assemblies are automatically controlled, by a combustion control computing device, to alternate the total gas flow for the at least two of the two or more burner assemblies between a first total gas flow condition with a secondary gas flow rate at a secondary gas flow rate maximum value and a second total gas flow condition with the secondary gas flow rate at a secondary gas flow rate minimum value to provide enhanced staged oxygen combustion.

According to an embodiment, the secondary gas flow rate maximum value is in a range from about 10% to about 70% of the total gas flow.

According to an embodiment, the secondary gas flow rate minimum value is less than the secondary gas flow rate maximum value.

According to an embodiment, the secondary gas flow rate maximum value and the secondary gas flow rate minimum value are different values for each of the at least two of the two or more burner assemblies.

According to an embodiment, the automatically controlling of the method further comprises controlling, by the combustion control computing device, the primary gas flow control valve and the secondary gas flow control valve to provide the first total gas flow condition for a first period of time; and controlling, by the combustion control computing device, the primary gas flow control valve and the secondary gas flow control valve to provide the second total gas flow condition after the first period of time has lapsed.

According to an embodiment, the first period of time is based on at least one condition in the glass furnace.

According to an embodiment, the at least one condition in the glass furnace comprises a batch profile or a furnace temperature.

According to an embodiment, the first period of time is a fixed value.

According to an embodiment, the first period of time is variable.

According to an embodiment, the first period of time is based on a position of at least one of the two or more burner assemblies in the glass furnace or an amount of fuel for the at least one of the two or more burner assemblies.

Another aspect of the present disclosure relates to a system for providing automatic enhanced staged oxygen combustion in a glass furnace. The system includes two or more burner assemblies each positioned to provide a flame in the glass furnace. Each of the two or more burner assemblies include a burner body comprising a primary gas inlet for receiving a primary gas flow from a gas source, the primary gas inlet in fluid communication with the gas source through a primary gas flow control valve configured to adjust a primary gas flow rate of the primary gas flow, and a staged injector sub-assembly comprising a secondary gas inlet for receiving a secondary gas flow from the gas source, the secondary gas inlet in fluid communication with the gas source through a secondary gas flow control valve configured to adjust a secondary flow rate of the secondary gas flow. A total gas flow for each of the two or more burner assemblies is provided by the primary gas flow and the secondary gas flow. A combustion control computing device is coupled to the primary gas flow control valve and the secondary gas flow control valve of each of the two or more burner assemblies. The combustion control computing device includes a memory coupled to a processor which is configured to be capable of executing programmed instructions comprising and stored in the memory to automatically control the primary gas flow control valve and the secondary gas flow control valve of at least two of the two or more burner assemblies to alternate the total gas flow for the at least two of the two or more burner assemblies between a first total gas flow condition with a secondary gas flow rate at a secondary gas flow rate maximum value and a second total gas flow condition with the secondary gas flow rate at a secondary gas flow rate minimum value to provide enhanced staged oxygen combustion.

According to an embodiment, the secondary gas flow rate maximum value is in a range from about 10% to about 70% of the total gas flow.

According to an embodiment, the secondary gas flow rate minimum value is less than the secondary gas flow rate maximum value.

According to an embodiment, the secondary gas flow rate maximum value and the secondary gas flow rate minimum value are different values for each of the at least two of the two or more burner assemblies.

According to an embodiment, the processor is configured to be capable of executing additional programmed instructions to: control the primary gas flow control valve and the secondary gas flow control valve to provide the first total gas flow condition for a first period of time; and control the primary gas flow control valve and the secondary gas flow control valve to provide the second total gas flow condition after the first period of time has lapsed.

According to an embodiment, the first period of time is based on at least one condition in the glass furnace.

According to an embodiment, the at least one condition in the glass furnace comprises a batch profile or a furnace temperature.

According to an embodiment, the first period of time is a fixed value.

According to an embodiment, the first period of time is variable.

According to an embodiment, the first period of time is based on a position of at least one of the two or more burner assemblies in the glass furnace or an amount of fuel for the at least one of the two or more burner assemblies.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The foregoing will be apparent from the following more particular description of example embodiments of the present disclosure, as illustrated in the accompanying drawings in which like reference characters refer to the same parts throughout the different views. The drawings are not necessarily to scale, emphasis instead being placed upon illustrating embodiments of the present disclosure.

FIG. 1 is a partial schematic and partial block diagram of an enhanced staged oxygen control (ESOC) combustion system according to aspects of the present disclosure.

FIG. 2 is a side elevational view of a burner and block assembly according to aspects of the present disclosure.

FIG. 3 is atop plan view of a flat flame burner sub-assembly and flat flame burner block according to aspects of the present disclosure.

FIG. 4 is a side elevational view of a gas nozzle and fuel nozzle according to aspects of the present disclosure.

FIG. 5A is a front view of a gas nozzle and fuel nozzle according to aspects of the present disclosure.

FIG. 5B is a rear view of a gas nozzle and fuel nozzle according to aspects of the present disclosure.

FIG. 6 is a side elevational view of a burner and block assembly according to aspects of the present disclosure.

FIG. 7 is a front perspective view of a staged injector sub-assembly according to aspects of the present disclosure.

FIG. 8 is a side elevational view of a staged injector sub-assembly and staged injector block according to aspects of the present disclosure.

FIG. 9A is a rear side elevational view of a staged injector sub-assembly and staged injector block according to aspects of the present disclosure.

FIG. 9B is a top plan view of a staged injector sub-assembly and staged injector block according to aspects of the present disclosure.

FIG. 10A is a front side elevational view of a staged injector sub-assembly according to aspects of the present disclosure.

FIG. 10B is a side elevational view of a staged injector sub-assembly according to aspects of the present disclosure.

FIG. 11 is a front perspective view of a staged injector block according to aspects of the present disclosure

FIG. 12A is a front elevational view of a staged injector block according to aspects of the present disclosure.

FIG. 12B is a rear elevational view of a staged injector block according to aspects of the present disclosure.

FIG. 13A is a top, cross-sectional view of a staged injector block according to aspects of the present disclosure.

FIG. 13B is a side, partial cross-sectional view of a staged injector block according to aspects of the present disclosure.

FIG. 14A is a side elevational view of a block and burner assembly according to aspects of the present disclosure.

FIG. 14B is a side elevational view of a block and burner assembly according to aspects of the present disclosure.

FIG. 15 is a block diagram of a combustion control computing device according to aspects of the present disclosure.

FIG. 16 is a flowchart of an exemplary method for providing enhanced staged oxygen control oxygen combustion according to aspects of the present disclosure.

### DETAILED DESCRIPTION

The present disclosure is directed generally to methods of oxygen combustion, and more specifically, to methods for providing enhanced staged oxygen control oxygen combustion and devices thereof. The systems for providing automatic enhanced staged oxygen combustion include two or more burner assemblies, each of the two or more burner assemblies including a burner body having a first or primary gas inlet configured to receive a primary gas flow that has an adjustable primary gas flow rate and a staged injector sub-assembly having a second or secondary gas inlet configured to receive a secondary gas flow that has an adjustable secondary gas flow rate. The systems further include a combustion control computing device coupled to the primary gas flow control valve and the secondary gas flow control valve of each of the two or more burner assemblies, the combustion control computing device configured to: automatically control the primary gas flow control valve and the secondary gas flow control valve of at least two of the two or more burner assemblies. The automatic control alternates a total gas flow for the at least two of the two or more burner assemblies between a first total gas flow condition and a second total gas flow condition to provide enhanced staged oxygen combustion. The first total gas flow condition comprises a secondary gas flow rate maximum value of the secondary gas flow rate. The second total gas flow condition comprises a secondary gas flow rate minimum value of the secondary gas flow rate. The methods for providing automatic enhanced staged oxygen combustion include providing the two or more burner assemblies and automatically controlling, by the combustion control computing device, the primary gas flow control value and the secondary gas flow control valve to alternate the total gas flow between a first total gas flow condition with the secondary gas flow rate at a secondary gas flow rate maximum value and a second total gas flow condition with the secondary gas flow rate at a secondary gas flow rate minimum value to provide enhanced staged oxygen combustion.

A description of example embodiments of the present disclosure follows. Although the block and burner assembly shown in the figures is shown in an upward orientation, the description of the assembly shown in the figures is not intended to be limited to a particular orientation.

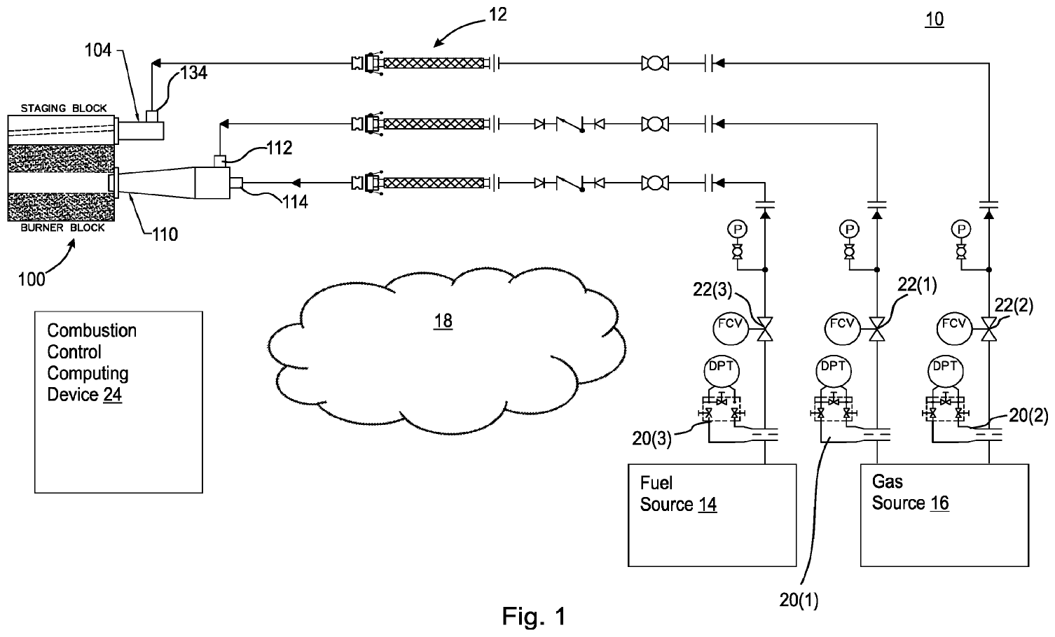

An example of an environment 10 including an enhanced staged oxygen control (ESOC) combustion system 12, a fuel source 14, a gas source 16, and one or more communication networks 18, is illustrated in FIG. 1. In this particular example, ESOC system 12 includes a block and burner assembly 100 having a flat flame burner body 110 with a first or primary gas inlet 112 and a first fuel inlet 114, and a staged injector sub-assembly 104, positioned separate and above flat flame burner body 100, and having a secondary gas inlet 134, although the block and burner assembly 100 can include other types and/or numbers of elements as described in further detail below.

ESOC system 12 further includes a primary gas flow meter 20(1), a secondary gas flow meter 20(2), a fuel flow meter 20(3), a primary gas flow control valve 22(1), a secondary gas flow control valve 22(2), a fuel flow control valve 22(3), and a combustion control computing device 24, although ESOC system 12 may include other types and/or numbers of components and/or other elements in other combinations, including additional electronics, such as analog to digital converters, as well as additional block and burner assemblies and associated flow meters and valves. ESOC system 12 advantageously provides for automated control of the amount of staged gas, such as oxygen, provided during the glass melting process. Automated control of the amount of staged gas allows for pulsing of the staged gas to produce variation in CO and pressure over the glass surface and glass foam to minimize the secondary foam produced to improve the overall oxy-fuel combustion glass melting process.

Although a single block and burner assembly 100 is illustrated in FIG. 1, it is to be understood that ESOC system 12 can be employed, by way of example only, in an oxygen fuel fired furnace, such as a glass melting furnace, with either a pair of block and burner assemblies or with multiple block and burner assemblies. In one example, ESOC system 12 is incorporated in a glass melting furnace having multiple block and burner assemblies with pairs of burner and block assemblies firing either directly across from one another or in a staggered arrangement along the length of the glass melting furnace.

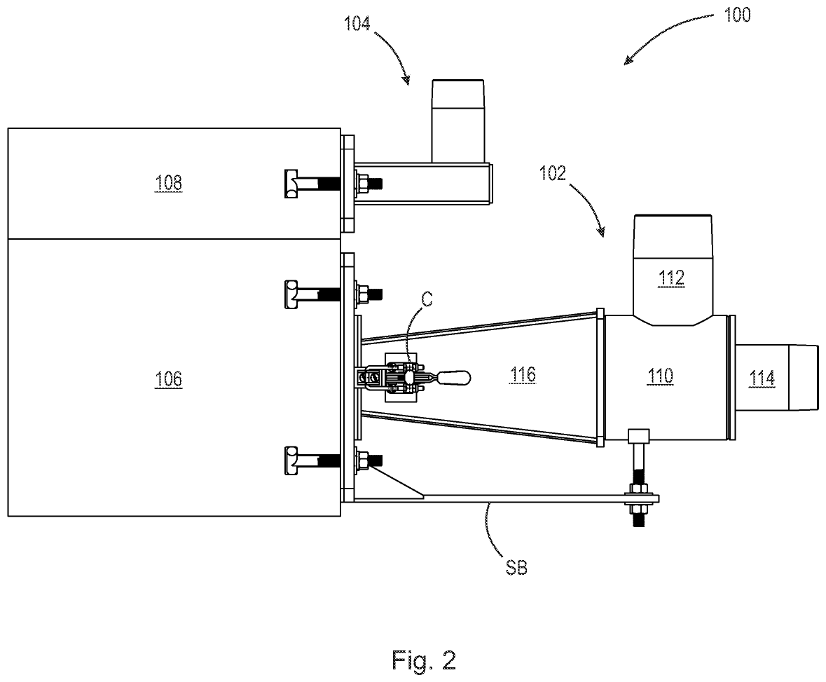

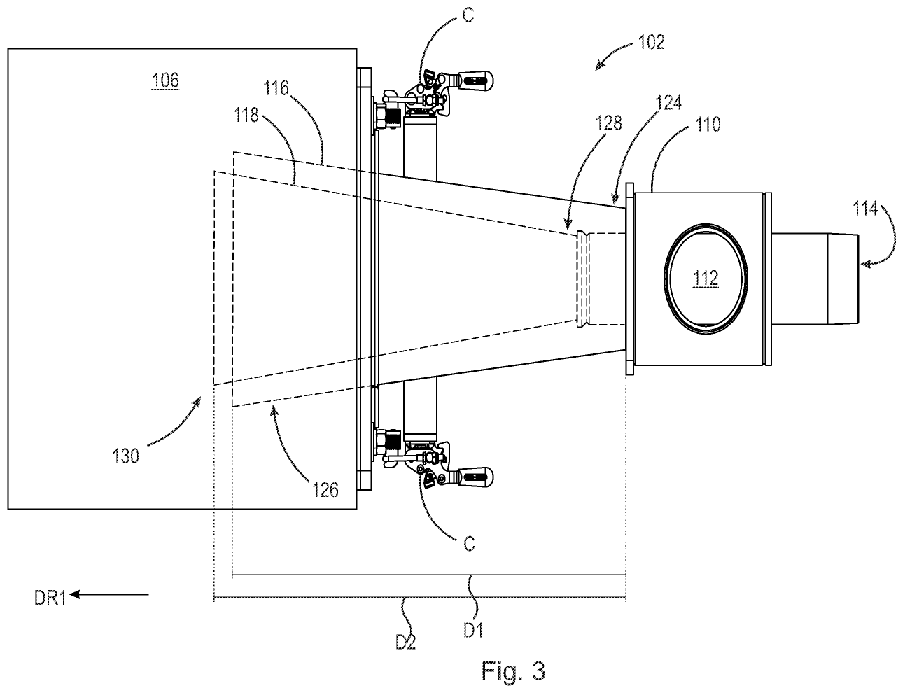

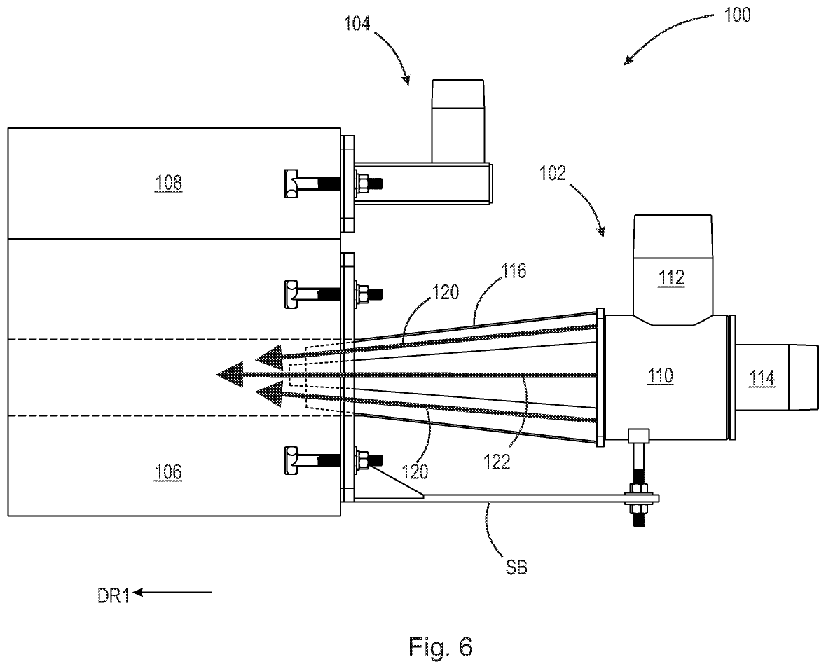

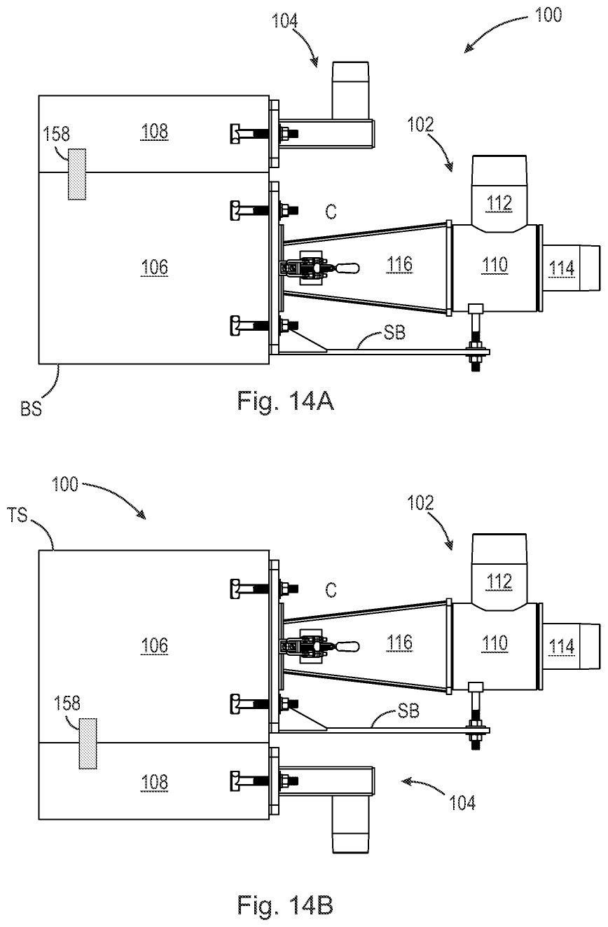

An exemplary block and burner assembly 100 that may be employed in ESOC system 12 is illustrated in FIGS. 2-14B, although the methods disclosed herein may be employed with other block and burner assemblies with separate inlets for staged gas and primary gas to the block and burner assembly. FIG. 2 illustrates a side elevational view of block and burner assembly 100 according to the present disclosure. Block and burner assembly 100 includes flat flame burner sub-assembly 102 and staged injector sub-assembly 104. Block and burner assembly 100 further includes flat flame burner block 106 arranged to receive at least a portion of flat flame burner sub-assembly 102 and staged injector block 108 arranged to receive staged injector sub-assembly 104. In one example, flat flame burner block 106 includes a top surface TS and a bottom surface BS (shown in FIGS. 14A-14B). It should be appreciated that flat flame burner block 106 and staged injector block 108 can be made from highly insulative thermal materials, e.g., refractory ceramic materials or any other material capable of insulating the heat generated in the combustion processes described below. As will be discussed below in detail, flat flame burner sub-assembly 102 is arranged to receive a gas 120 (shown in FIG. 6) and a fuel 122 (shown in FIG. 6) from gas source 16 (FIG. 1) and fuel source 14 (FIG. 1) and generate combustion within flat flame burner block 106. Flat flame burner sub-assembly 102 can be removably secured to flat flame burner block 106 via at least one clasp C as illustrated in FIGS. 2-3. Additionally, as will be discussed below in further detail, staged injector sub-assembly 104 and stage injector block 108 are separable from flat flame burner sub-assembly 102 and flat flame burner block 106.

Flat flame burner sub-assembly 102 includes flat flame burner body 110. Flat flame burner body 110 is intended to be a single unitary body made from stainless steel, e.g., 303, 304, or 310 grade stainless steel, and can have a plurality of apertures arranged to receive the various components discussed below, which engage with flat flame burner body 110. In one example, the components discussed below are integral with flat flame body 110 or may be secured to these apertures via friction fit. Additionally, these apertures may have embossed or molded female or male helical threads arranged to receive complementary female or male threading of the various components which engage with flat flame burner body 110 as will be described below. Flat flame burner sub-assembly 102 further includes first gas inlet 112, first fuel inlet 114, first gas nozzle 116, and first fuel nozzle 118 (shown in FIG. 3). Additionally, as illustrated in FIGS. 2, 6, and 14A-14B, flat flame burner body 110 may also be arranged to engage with a flat flame burner sub-assembly support bracket SB secured to flat flame burner block 106 to support the weight of flat flame burner sub-assembly 102 during operation.

As illustrated in FIG. 3, which shows a top plan view of flat flame burner sub-assembly 102 and flat flame burner block 108, first gas inlet 112 is arranged to engage with flat flame burner body 110 in at least one of the ways described above and is also arranged in fluid communication with gas source 16 (FIG. 1) such that a gas 120 (shown in FIG. 6) can be provided from gas source 16 into first gas inlet 112 and into flat flame burner body 110. First gas inlet 112 is intended to be a tubular member and can be made from stainless steel, e.g., 303, 304, or 310 grade stainless steel. It should be appreciated that first gas inlet 112 can take any size or form sufficient to provide the appropriate volume of gas 120 into flat flame burner body 110 and subsequently into first gas nozzle 116 as will be described below. Gas 120 is intended to be oxygen or a gaseous mixture containing a substantial portion of oxygen. It should be appreciated that other gaseous mixtures could be utilized, e.g., gaseous mixtures comprising oxygen or any other gaseous oxidant that supports combustion processes.

First fuel inlet 114 is arranged to engage with flat flame burner body 110 in at least one of the ways described above and is also arranged in fluid communication with fuel source 14 (FIG. 1) such that a fuel 122 (shown in FIG. 6) can be provided from fuel source 14 into first fuel inlet 114 and into flat flame burner body 110. Similar to first gas inlet 112 as discussed above, first fuel inlet 114 is intended to be a tubular member and can be made from stainless steel, e.g., 303, 304, or 310 grade stainless steel. It should be appreciated that first fuel inlet 114 can take any size or form sufficient to provide the appropriate volume of fuel 122 into flat flame burner body 110 and subsequently into first fuel nozzle 118 discussed below. Fuel 122 can be selected from: Methane, Propane, Butane, Hydrogen, Natural Gas, Carbon Monoxide, a combination of any of the foregoing, or any other gaseous fuel capable of auto-ignition at high temperatures.

As illustrated in FIG. 3, first gas nozzle 116 includes first end 124 and second end 126. It should be appreciated that first end 124 is arranged to engage with flat flame burner body 110 in any of the ways described above. For example, first end 124 may have an outer circumferential surface having threads machined thereon arranged to engage with complementary threads machined onto flat flame burner body 110. These threads can have various thread counts, i.e., threads per inch, and can vary from a low thread count having the advantage of being cheaper to manufacture at the cost of precision to having a high thread count with high precision with the disadvantage of increased cost of manufacturing. Second end 126 of first gas nozzle 116 is arranged such that it terminates, or ends, at a first distance D1 measured from flat flame burner body 110 in first direction DR1 with respect to flat flame burner body 110. Additionally, first gas nozzle 116 further includes a through-bore arranged to extend along the length of first gas nozzle 116 from first end 124 to second end 126.

Additionally, flat flame burner sub-assembly 102 also includes first fuel nozzle 118. First fuel nozzle 118 includes first end 128 and second end 130. It should be appreciated that first end 128 is arranged to engage with flat flame burner body 110 in any of the ways described above. Additionally, as illustrated, first end 128 of first fuel nozzle 118 is arranged to be secured to first fuel inlet 114 which is arranged to extend through the cavity created within flat flame burner body 110. For example, first end 128 may have an outer circumferential surface having threads machined thereon arranged to engage with complementary threads machined onto flat flame burner body 110 or first fuel inlet 114. These threads can have various thread counts, i.e., threads per inch, and can vary from a low thread count having the advantage of being cheaper to manufacture at the cost of precision to having a high thread count having high precision with the disadvantage of increased cost of manufacturing. Second end 130 of first fuel nozzle 118 is arranged such that it terminates, or ends, at a second distance D2 measured from flat flame burner body 110 in first direction DR1 with respect to flat flame burner body 110, where second distance D2 is greater than first distance D1. It should also be appreciated that, although not shown, flat flame burner sub-assembly 102 may be arranged such that first gas nozzle 116 and first fuel nozzle 118 terminate at the same distance with respect to flat flame burner body 110, e.g., where first distance D1 is equal to second distance D2 in first direction DR1. As shown in FIGS. 2 and 3, first fuel nozzle 118 is at least partially encompassed circumferentially within the through-bore of first gas nozzle 116.

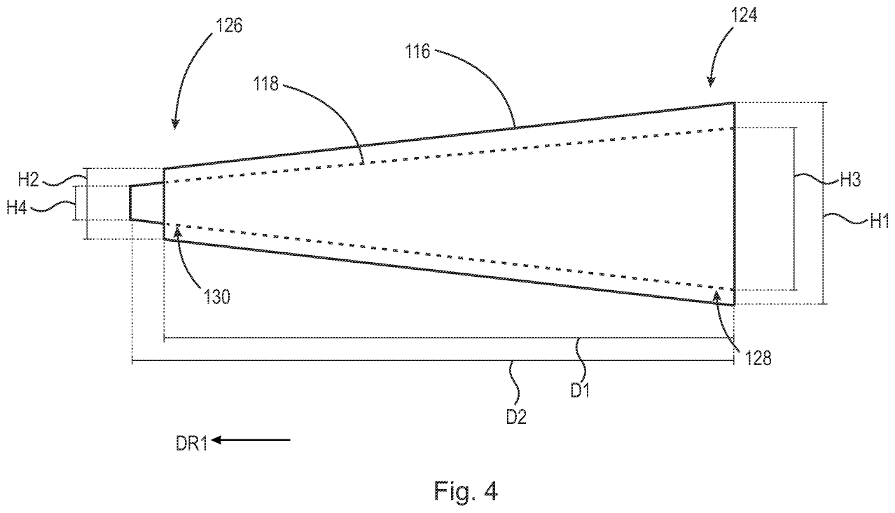

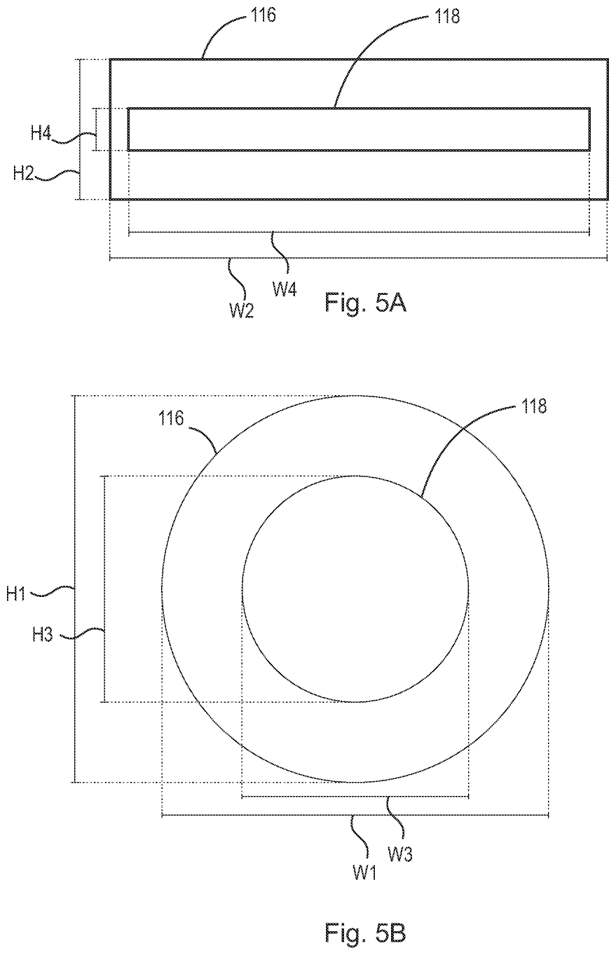

The following description should be read in view of FIGS. 4-5B. FIG. 4 illustrates a side elevational view of flat flame burner sub-assembly 102. FIGS. 5A and 5B illustrate a front side elevational view and rear side elevational view, respectively, of first gas nozzle 116 and first fuel nozzle 118. As illustrated in FIGS. 4-5B, first gas nozzle 116 has first end 124 and second end 126, where the first end 124 is arranged proximate flat flame burner body 110 when secured within flat flame burner sub-assembly 102. At the first end 124 of first gas nozzle 116, the nozzle aperture has a first height H1 and a first width W1. In an example, the aperture arranged at the first end 124 of first gas nozzle 116 is circular and has a first height H1 between 75-130 mm (approximately 3-5 inches) and has a first width W1 also between 75-130 mm (approximately 3-5 inches). It should be appreciated that the nozzle aperture at the first end 124 of first gas nozzle 116 can take any shape and have any size so as to provide an appropriate volume of gas 120 (shown in FIG. 6) to the combustion process described herein. At the second end 126 of first gas nozzle 116, the nozzle aperture has a second height H2 and a second width W2, where second height H2 is less than first height H1 and second width W2 is greater than first width W1. In one example, second height H2 is approximately 40-65 mm (approximately 1.5-2.5 inches) and second width W2 is approximately 150-175 mm (approximately 6-7 inches). The tapered nozzle shape described above operates to funnel and reshape the gas flow of gas 120 (shown in FIG. 6) as it exits second end 126 of first gas nozzle 116 such that gas 120 is evenly provided across second width W2 and mixes with fuel 122 to aid in combustion as will be described below.

Additionally, first fuel nozzle 118 has first end 128 and a second end 130, where the first end 128 is arranged proximate flat flame burner body 110 when secured within flat flame burner sub-assembly 102. At the first end 128 of first gas nozzle 116, the nozzle aperture has a third height H3 and a third width W3. In an example, the aperture arranged at the first end 128 of first fuel nozzle 118 is circular and has a third height H3 between 50-75 mm (approximately 2-3 inches) and has a third width W3 also between 50-75 mm (approximately 2-3 inches). It should be appreciated that the nozzle aperture at the first end 128 of first fuel nozzle 118 can take any shape and have any size so as to provide an appropriate volume of fuel 122 (shown in FIG. 6) to the combustion process described herein. At the second end 130 of first fuel nozzle 118, the nozzle aperture has a fourth height H4 and a fourth width W4, where fourth height H4 is less than third height H3 and fourth width W4 is greater than third width W3. In one example, fourth height H4 is approximately 10-40 mm (approximately 0.5-1.5 inches) and fourth width W4 is approximately 115-165 mm (approximately 4.5-6.5 inches). The tapered nozzle shape described above operates to funnel and reshape the flow of fuel 122 (shown in FIG. 6) as it exits second end 130 of first fuel nozzle 118 such that fuel 122 is evenly provided across fourth width W4 and mixes with gas 120 to aid in combustion as will be described below.

As illustrated in FIG. 6, during operation, gas 120 is permitted to flow from gas source 16 (FIG. 1) to first gas inlet 112 of flat flame burner body 110 at a primary gas flow rate controlled by primary gas flow control valve 22(1) (FIG. 1). Gas 120 is forced to flow from flat flame burner body 110 in first direction DR1 and within first gas nozzle 116. Gas 120 flows circumferentially outward of first fuel nozzle 118 and from first end 124 to second end 126 of first gas nozzle 116. The tapered transition from first height H1 and first width W1 of first gas nozzle 116 to second height H2 and second width W2 shapes gas 120 as it exits second side 126 of first gas nozzle 116 to be used in combustion within flat flame burner block 106. Simultaneously, fuel 122 is permitted to flow from fuel source 14 (FIG. 1) to first fuel inlet 114 of flat flame burner body 110 at a fuel flow rate controlled by fuel flow control valve 22(3) (FIG. 1). Fuel 122 is forced to flow from first fuel inlet 114 in first direction DR1 and within first fuel nozzle 118. Fuel 122 flows within first fuel nozzle 118 from first end 128 to second end 130. The tapered transition from third height H3 and third width W3 of first fuel nozzle 118 to fourth height H4 and fourth width W4 shapes the gaseous fuel 122 as it exits second end 130 of first fuel nozzle 118 to be used in combustion within flat flame burner block 106. The tapered transitions of first gas nozzle 116 and first fuel nozzle 118 create combustion with a flat shaped flame, i.e., a flame that is substantially flat and spans the width of the through-bore in flat flame burner block 106. A flat flame shape results in higher fuel efficiency of the entire burner system.

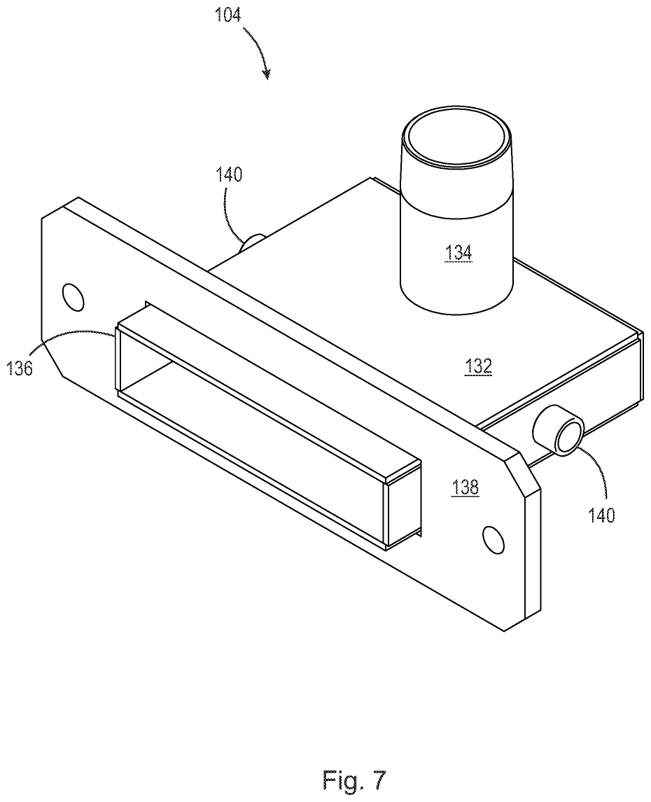

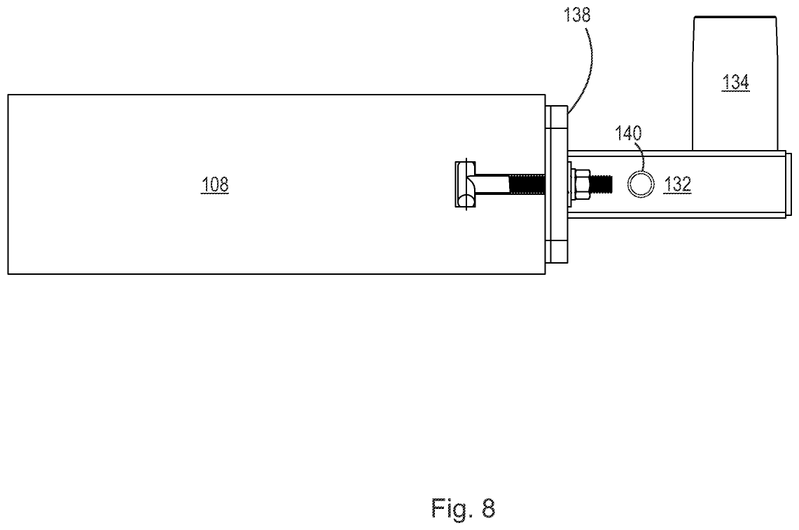

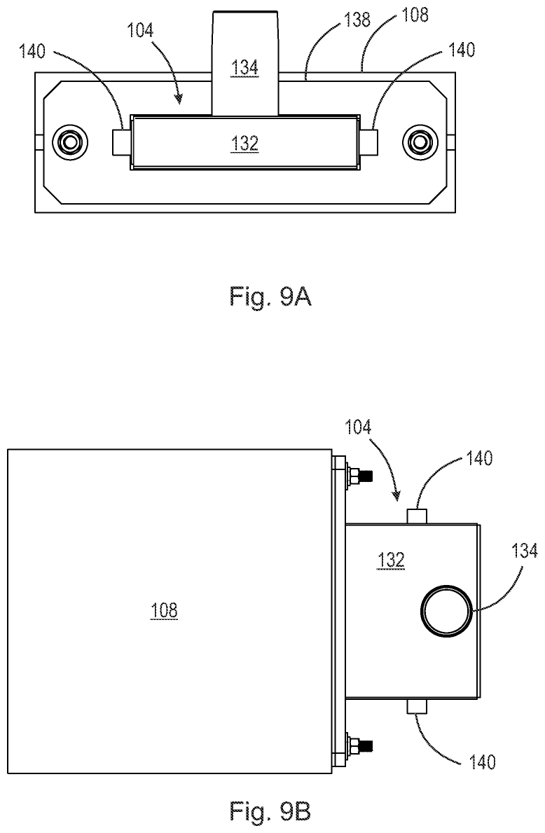

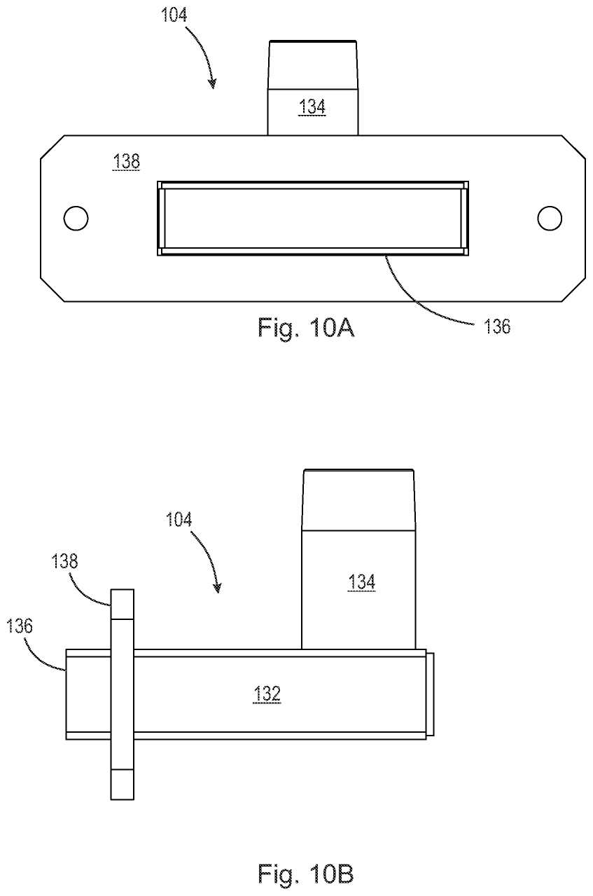

The following description should be read in view of FIGS. 7-10B. FIG. 7 illustrates a front perspective view of staged injector sub-assembly 104. FIG. 8 is a side elevational view of staged injector sub-assembly 104 secured to staged injector block 108. FIGS. 9A and 9B illustrate rear and top plan views, respectively, of staged injector sub-assembly 104 secured to staged injector block 108. Similarly, FIGS. 10A and 10B illustrate front and side views, respectively, of staged injector sub-assembly 104. Staged injector sub-assembly 104 includes a staged injector body 132. Staged injector body is intended to be a single unitary body made from stainless steel, e.g., 303, 304, or 310 grade stainless steel, and can have a plurality of apertures arranged to receive the various components discussed below, which engage with staged injector body 132. In one example, the components discussed below are integral with staged injector body 132 or may be secured to these apertures via friction fit. Additionally, these apertures may have embossed or molded female or male helical threads arranged to receive complementary female or male threading of the various components which engage with staged injector body 132 as will be described below.

Staged injector body 132 further includes second gas inlet 134, a staged injector nozzle 136, a flange 138, and at least one half coupling 140. Second gas inlet 134 is arranged to receive gas 120 from gas source 16 (FIG. 1) at a secondary gas flow rate controlled by the secondary gas control valve 22(2) (FIG. 1). Second gas inlet 134 is arranged to engage with staged injector body 132 in at least one of the ways described above and is also arranged in fluid communication with gas source 16 (FIG. 1) such that a gas 120 (shown in FIG. 6) can be provided from gas source 16 into second gas inlet 134 and into staged injector body 132. Second gas inlet 134 is intended to be a tubular member and can be made from stainless steel, e.g., 303, 304, or 310 grade stainless steel. It should be appreciated that second gas inlet 134 can take any size or form sufficient to provide the appropriate volume of gas 120 into staged injector body 132 and subsequently into staged injector nozzle 136 as will be described below. Staged injector nozzle 136 is arranged at one end of the staged injector body 132 and arranged to slidingly engage with recess 150 (discussed below) of staged injector block 108 such that gas 120 provided within staged injector body 132 can flow from staged injector body 132 into the plurality of gas channels 154A-154C (discussed below) of staged injector block 108. Moreover, so that staged injector nozzle 136 sits flush within recess 150, staged injector body 132 further includes a flange 138 arranged circumferentially about at least a portion of staged injector nozzle 136 and arranged to contact first side 142 (discussed below) of staged injector block 108 during operation of block and burner assembly 100. Flange 138 can include through-bores or apertures arranged to receive a fastener or bolt such that the bolt may secure the flange 138 and subsequently the staged injector body 132 to staged injector block 108. It should be appreciated that other fasteners may be used, including but not limited to, bolts, screws, or clasps, e.g., clasps C as illustrated in FIGS. 2-3 above. Additionally, staged injector body 132 may also include half couplings 140 arranged on or through at least a portion of staged injector body 132. It should be appreciated that half couplings 140 may be arranged to connect to external devices, such as but not limited to, pressure gauges, flow meters, etc.

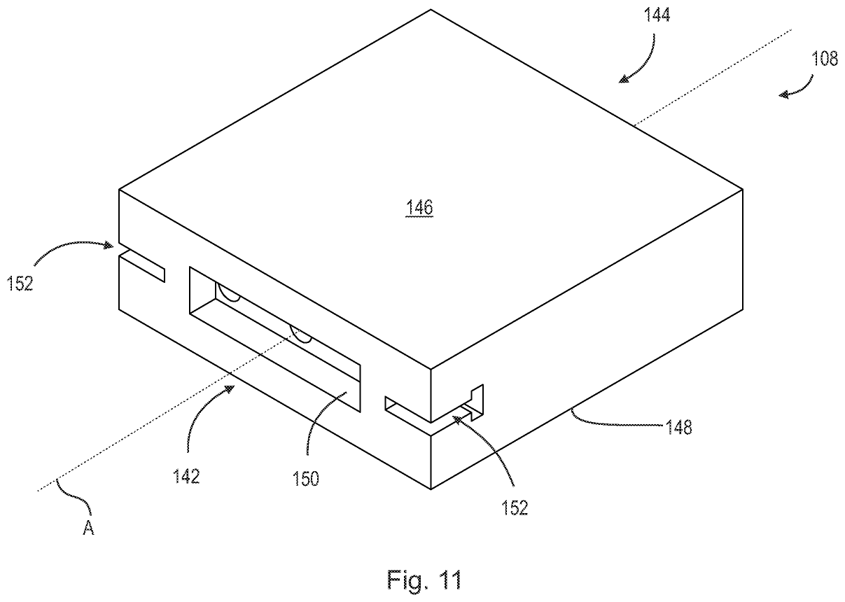

As discussed above, staged injector body 132 of staged injector sub-assembly 104 is arranged to be removably secured to staged injector block 108. As shown in FIGS. 11-13B, which illustrate perspective, front, back, top and side views of staged injector block 108, respectively, staged injector block 108 has a first side 142, a second side 144, atop surface 146 and a bottom surface 148. Proximate first side 142, staged injector block 108 includes a recess 150 and a fastener recess 152. Although recess 150 is illustrated as a rectangular depression, it should be appreciated that recess 150 can be any size or take any shape which complements the shape of staged injector nozzle 136 such that at least a portion of staged injector nozzle 136 extends into recess 150. Additionally, as discussed above, staged injector block 108 may further include one or more fastener recesses 152 arranged to receive a fastener such as a bolt or screw through the through-bores in flange 138 of staged injector sub-assembly 104.

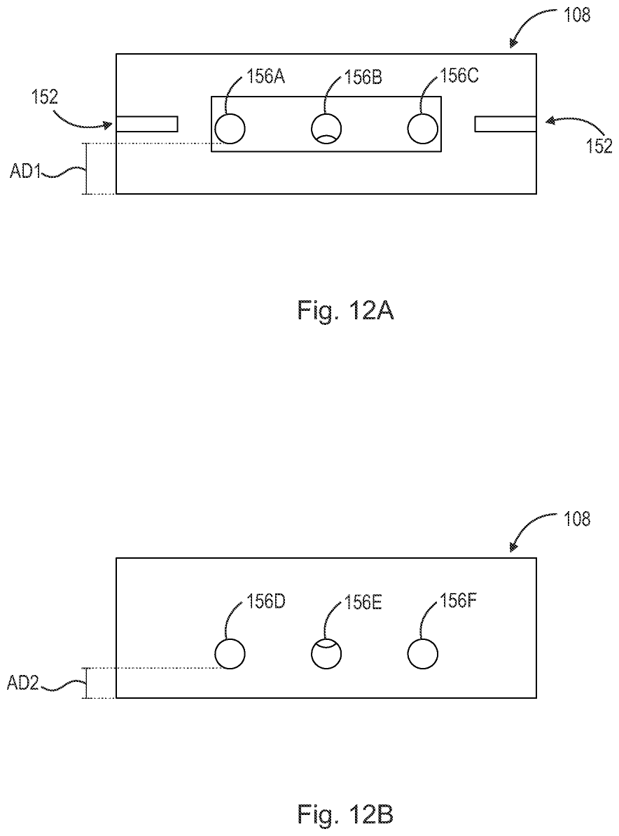

Staged injector block 108 further includes a plurality of gas channels 154A-154C (collectively referred to as “plurality of gas channels” or “plurality of gas channels 154”) which are arranged within and through staged injector block 108 and are arranged to span from first side 142 of staged injector block 108 to second side 144 of staged injector block 108. Additionally, staged injector block 108 further includes a plurality of apertures 156A-156F (collectively referred to as “plurality of apertures” or “plurality of apertures 156”). As illustrated in FIGS. 12A and 12B, each gas channel of plurality of gas channels 154 includes two apertures, one proximate first side 142 and one proximate second side 144. Thus, first side 142 includes three apertures 156A-156C of plurality of apertures 156, and second side 144 includes three apertures 156D-156F, i.e., two apertures for each channel. In one example, gas channel 154A begins proximate first side 142 with aperture 156A and terminates proximate second side 144 with aperture 156F. Similarly, gas channel 154B begins proximate first side 142 with aperture 156B and terminates proximate second side 144 with aperture 156E. Finally, gas channel 154C begins proximate first side 142 with aperture 156C and terminates proximate second side 144 with aperture 156D.

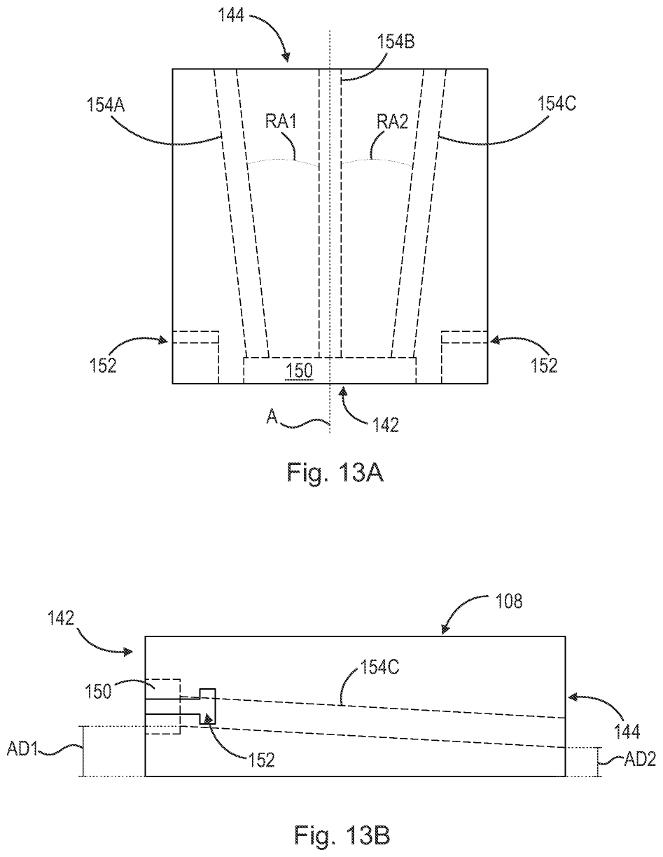

In one example, illustrated in FIGS. 12A-12B and 13B, each gas channel of plurality of gas channels 154 is arranged with a downward pitch or angle such that each gas channel is sloped from first side 142 to second side 144 in the direction of the flat flame burner block 106. Said another way, the apertures of each gas channel arranged proximate first side 142 (e.g., apertures 156A-156C) are arranged at a first aperture distance AD1 from the bottom surface 148 of staged injector block 108 (or from flat flame burner block 106 as bottom surface 148 and flat flame burner block are arranged to contact each other during operation). Additionally, the apertures of each gas channel arranged proximate second side 144 (e.g., apertures 156D-156F) are arranged at a second aperture distance AD2 from bottom surface 148 of staged injector block 108 (or from flat flame burner block 106), where the second aperture distance AD2 is less than the first aperture distance AD1. The differential in apertures distances of the first set of apertures and the second set of apertures results in gas channels with a downward slope, i.e., sloped in the direction of flat flame burner block 106 from first side 142 to second side 144.

In another example, each gas channel of plurality of gas channels 154 are arranged at different radial angles with respect to each other, i.e., are arranged non-parallel to each other. As illustrated in FIG. 13A, gas channel 154B is arranged substantially parallel with an imaginary center axis A arranged from first side 142 to second side 144 of staged injector block 108. Additionally, as shown in FIG. 13A, gas channel 154A is arranged at a first radial angle RA1 and gas channel 154C is arranged at a second radial angle RA2 with respect to the imaginary center axis A. In one example, first radial angle RA1 and second radial angle RA2 are selected from the range of 1-20 degrees, or more specifically, from the range of 5-8 degrees, or even more specifically, 6.47 degrees with respect to center axis A. In one example, first radial angle RA1 and second radial angle RA2 are selected such that gas channels 154A and 154C flare outward at appropriate radial angles with respect to center axis A as the gas channels proceed from first side 142 to second side 144 such that gas 120 that exits each gas channel is provided at a location that substantially matches the width (e.g., second width W2 of flat flame nozzle 116) of the flat flame produced by flat flame burner sub-assembly 102 as discussed above. The availability of this additional staging gas 120 after initial combustion by the flat flame burner sub-assembly 102, increases the efficiency of the overall block and burner system 100. Moreover, the ability to separately adjust the secondary gas flow, i.e., the flow of gas 120 through staged injector sub-assembly 104 and into staged injector block 108, allows for enhanced flame control of the flat flame produced by the flat flame burner sub-assembly 102, as described in further detail below. In one example, the ratio and flow rate of gas 120 through staged injector sub-assembly 104 can be adjusted using secondary gas control valve 22(2) to increase or decrease the length of the flame produced by the system, and/or increase or decrease the width of the flame produced within the through-bore of flat flame burner block 106.

The staged arrangement of block and burner assembly 100 allows the ratio of gas 120 to fuel 122 to be adjusted and/or separated for increased burner efficiency of the combustion generated by flat flame burner sub-assembly 104, as described with respect to the examples discusses below. In one example, the ratio of gas 120 to fuel 122 fired through the flat flame burner sub-assembly is 1:1, while the remaining portion of gas 120 is provided by the staged injector sub-assembly 104. By providing the additional staged gas through the plurality of gas channels 154 as discussed above, the overall efficiency and control of the flames produced by the system can be controlled with enhanced precision.

In this example, staged injector block 108 is arranged to sit atop flat flame burner block 106 (e.g., in contact with top surface TS) during operation of block and burner assembly 100. A bracket 158 or other mechanism arranged between flat flame burner block 106 and staged injector block 108 to secure the blocks to each other and prevent them from moving relative to each other during operation. The arrangement of staged injector block 108 atop flat flame burner body 106 in this example is advantageous for providing enhanced combustion to reduce secondary foam during a glass melting process as described in the examples set forth below.

The foregoing block and burner system, e.g., block and burner assembly 100 has several advantages. First, flat flame burner sub-assembly 102 produces a flat flame during the combustion process discussed above which increases overall burner efficiency. Second, the foregoing block and burner assembly allows for enhanced control of the flat flame produced in flat flame burner sub-assembly 102 by allowing for precise control of staging gases through staged injector sub-assembly 104 and staged injector block 108. Third, as the materials used for both the flat flame burner block 106 and the staged injector block 108 are typically brittle and susceptible to cracking during repeated combustion operations, the foregoing block and burner assembly 100 allows for replacement and/or repair of each portion of block, i.e., flat flame burner block 1086 or staged injector block 108 independently. Furthermore, having the two blocks separable as described above, prevents a crack that begins in one block from travelling to the other block. Lastly, the first gas nozzle 116 and first fuel nozzle 118 of flat flame burner sub-assembly 102 are arranged to extend a first distance D1 from the body of the sub-assembly and a second distance D2 from the body of the sub-assembly, respectively, where the first distance D1 is less than or equal to the second distance D2. This nozzle arrangement prevents gas 120 from first gas nozzle 116 from mixing with fuel 122 from first fuel nozzle 118 before it leaves the flat flame burner sub-assembly. External mixing of gas 120 and fuel 122 helps prevent backfiring and reduces operating temperatures of the sub-assembly.

Referring again to FIG. 1, in this example, first gas inlet 112 of flat flame body burner 110 is in fluid communication with gas source 16 through primary gas flow meter 20(1) and primary gas flow control valve 22(1) for receiving a primary gas flow from gas source 16. Second gas inlet 134 of staged injector sub-assembly 104 is in fluid communication with gas source 16 through secondary gas flow meter 20(2) and secondary gas flow control valve 22(2) for receiving a secondary gas flow from gas source 16 to provide a separate staged gas inlet. In this example, second gas inlet 134 is located above the first gas inlet 112 during operation of block and burner assembly 100. First fuel inlet 114 of flat flame burner body 110 is in fluid communication with fuel source 14 through fuel flow meter 20(3) and fuel flow control valve 22(3) for receiving a fuel flow from the fuel source.

Each of flow meters 20(1)-20(3) are operatively coupled to combustion control computing device 24 through one or more communication networks 18 to provide flow readings to control computing device 24. Flow meters 20(1)-20(3) may be any flow meters configured to measure the flow of a fluid known in the art. Control valves 22(1)-22(3) are also operatively coupled to combustion control computing device 24 through one or more communication networks 18 such that combustion control computing device 24 can provide instructions to control the operation of control valves 22(1)-22(3) to control the flow of gas or fuel provided to block and burner assembly 100. Control valves 22(1)-22(3) can be any control valves configured to operatively adjust the amount of flow of a fluid provided to the various inlets of block and burner assembly 100.

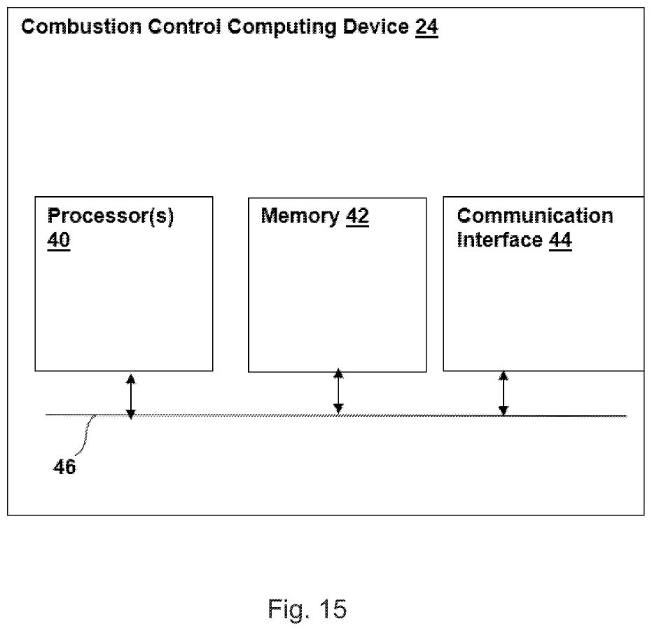

Referring now to FIG. 15, in this example, combustion control computing device 24 includes one or more processor(s) 40, a memory 42, and a communication interface 44, which are coupled together by a bus 46 or other communication link, although combustion control computing device 24 can include other types and/or numbers of elements in other configurations.

Processor(s) 40 of combustion control computing device 24 may execute programmed instructions stored in memory 42 for any number of the functions described and illustrated herein. In one example, processor(s) 40 receive information from flow meters 20(1)-20(3) and provide instructions to the flow control valves 22(1)-22(3) for performance of the methods of automatic enhanced staged oxygen control described herein. Processor(s) 40 may include one or more CPUs, GPUs, or general purpose processors with one or more processing cores, for example, although other types of processor(s) can also be used such as FPGA devices.

Memory 42 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory.

Accordingly, memory 42 of combustion control computing device 24 can store one or more applications or programs that can include computer executable instructions that, when executed by processor(s) 40 of combustion control computing device 24, cause combustion control computing device 24 to perform actions described below. The application(s) can be implemented as modules, threads, pipes, streams, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s) may be running in one or more virtual machines (VMs) executing on combustion control computing device 24. Communication interface 44 operatively couples and communicates between combustion control computing device 24 and flow meters 20(1)-20(3) and flow control valves 22(1)-22(3). For example, combustion control computing device 24 can be configured to receive flow data from flow meters 20(1)-20(3) and to provide instructions to operatively control operation of the control valves 22(1)-22(3) to adjust the flow to block and burner assembly 100.

Although exemplary combustion control computing device 24 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for combustion control computing device 24. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

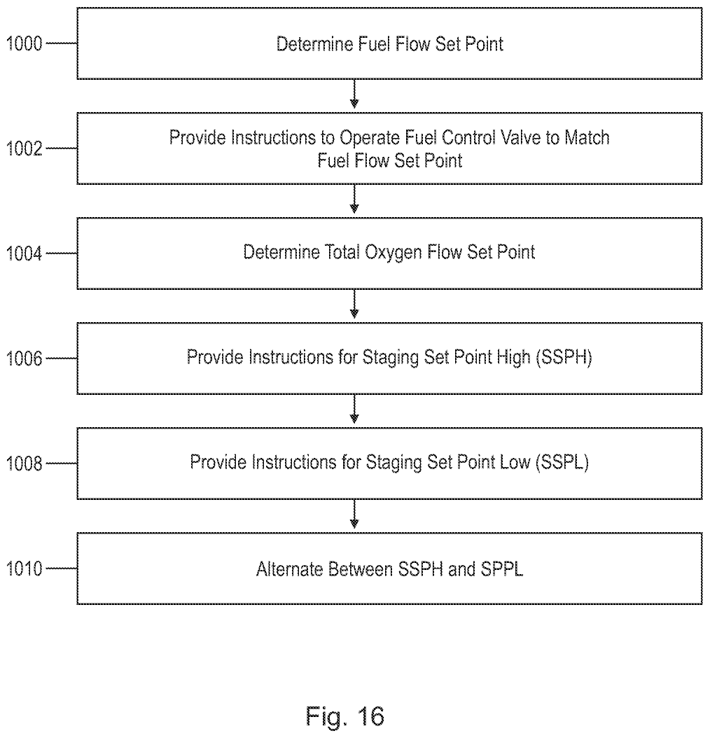

An exemplary method of automatic enhanced stage oxygen combustion will now be described with reference to FIGS. 1-16. Although the method is described with respect to a single block and burner assembly it is to be understood that the method could be performed with respect to other types and/or numbers of burners having separate gas inlets for staged and primary gas. In one example, the described method is performed for at least two burners, each having separate gas inlets for staged and primary gas, that are positioned to provide a flame in a glass furnace, although the described method may be employed for any number of burner assemblies.

First, in step 1000, a set point for fuel flow from fuel source 14 to fuel inlet 114 is determined by combustion control computing device 24 for each burner assembly employed, such as block and burner assembly 100. The fuel flow set point is determined based on known methods in the art for firing processes. Combustion control computing device 24 can be communicatively coupled to a device that provides the internal temperature such that combustion control computing device 24 can adjust the fuel flow set point based on the internal temperature readings. For example, the fuel flow set point can be based upon a temperature control loop in which the fuel flow set point is continuously adjusted based on an internal temperature of the furnace or based on other control settings.

In step 1002, combustion control computing device 24 provides instructions to operate fuel flow control valve 22(3) to match the fuel flow set point. In one example, combustion control computing device 24 utilizes data from fuel flow meter 20(3) to provide adjustment of fuel flow control valve 22(3). Combustion control computing device 24 provides instructions to fuel flow control valve 22(3) such that fuel flow modulates based upon temperature and other melting characteristics.

Next, in step 1004, a total oxygen flow set point is determined by combustion control computing device 24 based on an established ratio between fuel flow and gas flow for each burner, or an oxygen ratio set point. By way of example, the oxygen ratio set point can be stored in memory 42 of combustion control computing device 24. The oxygen ratio set point can vary from 1.60 to 2.75 and depends upon the type of fuel and calorific value, oxygen purity, desired excess oxygen, or other furnace or glass chemistry factors. The total oxygen flow set point can be calculated based on Equation (1) below or any other suitable alternative:

$$Total Oxygen Fl ow Se t Point = Fuel Flow * Oxygen Ratio Set Point \qquad ( 1 )$$

In some cases, the gas (e.g., oxygen) can drive the fuel use, or alternatively the fuel can drive the gas (e.g., oxygen) use. There are many known control schemes for total fuel flow in a glass furnace, as well as for individual burners that may be incorporated in the methods disclosed herein. In this example, the total gas flow for each burner in ESOC system 12 is provided by the combination of the primary gas flow provided from gas source 16 to first gas inlet 112 of burner body 110 and the secondary gas flow provided from gas source 16 to secondary (staged) gas inlet 134 in staged injector sub-assembly 104.

ESOC system 12 advantageously allows for completely separate, automatic control of the gas provided from gas source 16 to first gas inlet 112 (primary gas) and to second gas inlet 134 (staged gas). As a result, the total oxygen flow set point determined in step 1004 can then be utilized to pulse the staged oxygen to produce variation in carbon monoxide (CO) and pressure over the glass surface and glass foam thereby inhibiting and minimizing secondary foam. The staged gas set point is determined based on a staged gas percentage, as given by Equation (2) below or any suitable alternative:

$$Staged Oxygen Se t Point = Total Oxygen Flow * Sta ged Oxy gen Percent \qquad ( 2 )$$

The staged gas set point can advantageously be set to either a staging set point high (SSPH) or a staging set point low (SSPL) value by combustion control computing device 24 as described in further detail below. The SSPH value can be set between 10 to 70% of the total oxygen, for example, and the SSPL value is less than SSPH. The SSPH and SSPL values may be set to enhance burning conditions. Different burners in a glass furnace may be set to have different SSPH and SSPL values, although each burner could be set with the same SSPH and SSPL values. The primary oxygen set point is the given by Equation (3) below or any suitable alternative:

$$Primary Oxygen Set Point = Total Oxygen Flow Set Point * ( 1 - Staged Oxygen Percent ) \qquad ( 3 )$$

As described below, combustion control computing device 24 can provide instructions to control primary gas flow control valve 22(1) and secondary gas flow control valve 22(2) to alternate the staged gas flow at second gas inlet 134 (i.e., the staged oxygen) between the SSPH value and the SSPL value, while maintaining the total oxygen flow by also adjusting the amount of gas provided at first gas inlet 112 (i.e., the primary oxygen). The method described below improves the overall oxygen/fuel glass melting process.

In step 1006, control combustion computing device 24 provides instructions to control primary gas flow control valve 22(1) and secondary gas flow control valve 22(2) such that the staged gas (i.e., the amount of gas provided through second gas inlet 134) is set at SSPH, although in other examples the staged gas may initially be set at SSPL. The amount of gas provided through first inlet gas 112 is also adjusted to provide the total oxygen flow set point determined in step 1004 based on Equations (2) and (3). At the SSPH value for the staged oxygen provided at second gas inlet 134, which is located above first gas inlet 112 in this example, the block and burner assembly 100 produces a higher CO/reducing condition near the glass surface by diverting more of the oxygen to second gas inlet 134. In the SSPH condition, the flame provided by block and burner assembly 100 is also longer covering a larger area over the glass surface.

Control computing device 24 provides instructions to maintain the SSPH condition for a time factor set from 1 to a time factor high stage (TFHS) value. In one example, the TFHS value is variable and is controlled by combustion computing device 24 and can be based on data related to one or more conditions in the gas furnace, including batch profile as monitored by CCTV or other device, furnace temperatures as measured by a thermocouple, infrared or other device. In another example, the TFHS value is fixed. The TFHS value can also vary for each and every burner in a glass furnace that is controlled by the ESOC system 12. For example, the TFHS value for each burner may depend upon the position of the burner in the furnace and/or the amount of fuel in the burner, although the TFHS value may be based on other factors.

After the TFHS value has been reached, in step 1008 control combustion computing device 24 provides instructions to control primary gas flow control valve 22(1) and secondary gas flow control valve 22(2) such that the staged gas (i.e., the amount of gas provided through second gas inlet 134) is set at SSPL and the amount of gas provided through first inlet gas 112 is also adjusted to provide the total oxygen flow set point determined in step 1004 based on Equations (2) and (3). At the SSPL value for the staged oxygen provided at second gas inlet 134, the block and burner assembly 100 produces a lower CO/reducing condition near the glass surface as oxygen is diverted from the second gas inlet 134 to first gas inlet 112 of the block and burner assembly 100.

Control computing device 24 provides instructions to maintain the SSPL condition for a time factor set from 1 to a time factor low stage (TFLS) value. In one example, the TFLS value is variable and is controlled by combustion computing device 24 and can be based on data related to one or more conditions in the gas furnace, including batch profile as monitored by CCTV or other device, furnace temperatures as measured by a thermocouple, infrared or other device. In another example, the TFLS value is fixed. The TFLS value can also vary for each and every burner in a glass furnace that is controlled by the ESOC system 12. For example, the TFLS value for each burner may depending upon the position of the burner in the furnace and/or the amount of fuel on the burner, although the TFHS value may be based on other factors.

In step 1010, combustion control computing device 24 alternates between steps 1006 and 1008 to control primary gas flow control valve 22(1) and secondary gas flow control valve 22(2) to provide a pulsed staged oxygen level at second gas inlet 134 that automatically varies between SSPH and SSPL. Cycling between SSPH to SSPL creates the pulses in more reducing gases close to the glass surface. The pulses also cause changing pressure conditions close to the glass surface as the flame near the glass changes from a high staging condition to a low staging condition.

Although operation of a single burner is described, the ESOC system 12 of the present disclosure can be used to control at least two burners in a glass furnace, although other numbers of burners could be controlled using the disclosed ESOC system 12. Further, the method could be employed in a glass furnace having burners with fixed staged gas percentage or no staging. In this process the overall combustion is controlled by always ensuring the overall oxygen ratio is at or above stoichiometric. In this scheme, it is feasible to operate some burners in the glass furnace below stoichiometric ratio as long as some burners are set above stoichiometric ensuring complete combustion.

Accordingly, the present disclosure provides systems and methods that provide automatic enhanced staged oxygen combustion. More specifically, the systems methods of the present disclosure provide for automated control of the amount of staged gas, such as oxygen, provided during the glass melting process. Automated control of the amount of staged gas allows for pulsing the staged gas to produce variation in CO and pressure over the glass surface and glass foam to minimize the secondary foam produced to improve the overall oxy-fuel combustion glass melting process.

It should be understood that, unless clearly indicated to the contrary, in any methods claimed herein that include more than one step or act, the order of the steps or acts of the method is not necessarily limited to the order in which the steps or acts of the method are recited.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

1. A method for providing automatic enhanced staged oxygen combustion in a glass furnace, the method comprising:
providing two or more burner assemblies each positioned to provide a flame in the glass furnace, each of the two or more burner assemblies comprising:
a burner body comprising
a primary gas inlet for receiving a primary gas flow from a gas source, the primary gas inlet in fluid communication with the gas source through a primary gas flow control valve configured to adjust a primary gas flow rate of the primary gas flow; and
a staged injector sub-assembly separate from the burner body, the staged injector sub-assembly comprising a secondary gas inlet for receiving a secondary gas flow from the gas source, the secondary gas inlet in fluid communication with the gas source through a secondary gas flow control valve configured to adjust a secondary gas flow rate of the secondary gas flow, wherein a total gas flow for each of the two or more burner assemblies is provided by the primary gas flow and the secondary gas flow; and
automatically controlling, by a processor of a combustion control computing device, the primary gas flow control valve and the secondary gas flow control valve of each of the two or more burner assemblies to alternate the total gas flow for each of the two or more burner assemblies between a first total gas flow condition and a second total gas flow condition to provide enhanced staged oxygen combustion, wherein the first total gas flow condition comprises the secondary gas flow rate at a maximum value and the second total gas flow condition comprises the secondary gas flow rate at a minimum value, wherein the processor causes the alternating based on flow readings at primary and secondary gas flow meters proximate the gas source.

2. The method of claim 1, wherein the maximum value is in a range from about 10% to about 70% of the total gas flow.

3. The method of claim 1, wherein the minimum value is less than the maximum value.

4. The method of claim 1, wherein the maximum value and the minimum value are different values for each of the two or more burner assemblies.

5. The method of claim 1, wherein the automatically controlling further comprises:
controlling, by the combustion control computing device, the primary gas flow control valve and the secondary gas flow control valve to provide the first total gas flow condition for a first period of time; and
controlling, by the combustion control computing device, the primary gas flow control valve and the secondary gas flow control valve to provide the second total gas flow condition after the first period of time has lapsed.

6. The method of claim 5, wherein the first period of time is based on at least one condition in the glass furnace.

7. The method of claim 6, wherein the at least one condition in the glass furnace comprises a batch profile or a furnace temperature.

8. The method of claim 5, wherein the first period of time is a fixed value.

9. The method of claim 5, wherein the first period of time is variable.

10. The method of claim 5, wherein the first period of time is based on a position of at least one of the two or more burner assemblies in the glass furnace or an amount of fuel for the at least one of the two or more burner assemblies.

11. A system for providing automatic enhanced staged oxygen combustion in a glass furnace, the system comprising:
two or more burner assemblies each positioned to provide a flame in the glass furnace, each of the two or more burner assemblies comprising:
a burner body comprising
a primary gas inlet for receiving a primary gas flow from a gas source, the primary gas inlet in fluid communication with the gas source through a primary gas flow control valve configured to adjust a primary gas flow rate of the primary gas flow; and
a staged injector sub-assembly separate from the burner body, the staged injector sub-assembly comprising a secondary gas inlet for receiving a secondary gas flow from the gas source, the secondary gas inlet in fluid communication with the gas source through a secondary gas flow control valve configured to adjust a secondary gas flow rate of the secondary gas flow, wherein a total gas flow for each of the two or more burner assemblies is provided by the primary gas flow and the secondary gas flow; and
a combustion control computing device coupled to the primary gas flow control valve and the secondary gas flow control valve of each of the two or more burner assemblies, the combustion control computing device comprising a processor which is configured to be capable of executing programmed instructions to:
automatically control the primary gas flow control valve and the secondary gas flow control valve of each of the two or more burner assemblies to alternate the total gas flow for each of the two or more burner assemblies between a first total gas flow condition and a second total gas flow condition to provide enhanced staged oxygen combustion, wherein the first total gas flow condition comprises the secondary gas flow rate at a maximum value and the second total gas flow condition comprises the secondary gas flow rate at a minimum value, wherein the processor is configured to alternate the total gas flow based on flow readings at primary and secondary gas flow meters proximate the gas source.

12. The system of claim 11, wherein the maximum value is in a range from about 10% to about 70% of the total gas flow.

13. The system of claim 12, wherein the minimum value is less than the maximum value.

14. The system of claim 11, wherein the maximum value and the minimum value are different values for each of the two or more burner assemblies.

15. The system of claim 11, wherein the processor is configured to be capable of executing additional programmed instructions to:
control the primary gas flow control valve and the secondary gas flow control valve to provide the first total gas flow condition for a first period of time; and
control the primary gas flow control valve and the secondary gas flow control valve to provide the second total gas flow condition after the first period of time has lapsed.

16. The system of claim 15, wherein the first period of time is based on at least one condition in the glass furnace.

17. The system of claim 16, wherein the at least one condition in the glass furnace comprises a batch profile or a furnace temperature.

18. The system of claim 15, wherein the first period of time is a fixed value.

19. The system of claim 15, wherein the first period of time is variable.

20. The system of claim 15, wherein the first period of time is based on a position of at least one of the two or more burner assemblies in the glass furnace or an amount of fuel for the at least one of the two or more burner assemblies.
